(19) United States
(12) Patent Application Publication
(10) Pub. No.: US 2008/0152968 A1
(43) Pub. Date: Jun. 26, 2008

(54) Controlling oxidant flows in a fuel cell system

(76) Inventors: Zhi Zhou, Selkirk, NY (US); Vishnu Poonamallee, Tamilnadu (IN)

Correspondence Address: TROP PRUNER & HU, PC, 1616 S. VOSS ROAD, SUITE 750, HOUSTON, TX, 77057-2631, US

(21) Appl. No.: 11/645,119

(22) Filed: Dec. 22, 2006

(51) Int. Cl. H01M 8/04

(52) U.S. Cl. 429/14; 429/24

(57) ABSTRACT

A technique that is usable with a fuel cell includes generating first and second oxidant flows from a source oxidant flow. The first oxidant flow is communicated to a cathode chamber of the fuel cell, and the second oxidant flow is communicated to a reactor to oxidize an anode exhaust flow, which is provided by the fuel cell. The generation of the first oxidant flow is regulated based on a state of the reactor.

### BACKGROUND

The invention generally relates to controlling oxidant flows in a fuel cell system.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange membrane (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Catalyzed electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, a technique that is usable with a fuel cell includes generating first and second oxidant flows from a source oxidant flow. The first oxidant flow is communicated to a cathode chamber of the fuel cell, and the second oxidant flow is communicated to a reactor to oxidize an anode exhaust flow, which is provided by the fuel cell. The generation of the first oxidant flow is regulated based on a state of the reactor.

In another embodiment of the invention, a fuel cell system includes an oxidant source, a diverter, a fuel cell, a reactor and a controller. The oxidant source furnishes a source oxidant flow, and the diverter generates first and second oxidant flows from the source oxidant flow. The fuel cell includes a cathode chamber to receive a first oxidant flow and an anode chamber to provide an anode exhaust flow. The reactor receives the anode exhaust flow and the second oxidant flow and oxidizes the anode exhaust flow. The controller is coupled to the diverter to regulate the generation of the first oxidant flow in response to a state of the reactor.

In yet another embodiment of the invention, an article includes a computer accessible storage medium to store instructions that when executed cause a processor-system to control a diverter to generate first and second oxidant flows from a source oxidant flow. The first oxidant flow is communicated to a cathode chamber of a fuel cell, and the second oxidant flow is communicated to a reactor to oxidize an anode exhaust flow that is provided by the fuel cell. The instructions when executed also cause the processor-based system to regulate the generation of the first flow based on a state of the reactor.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a schematic diagram of a control architecture directed to controlling a cathode blower of the fuel cell system of FIG. 1 according to an embodiment of the invention.

FIG. 3 is a flow diagram depicting a technique to optimize an oxidant flow to a fuel cell stack of the fuel cell system according to an embodiment of the invention.

### DETAILED DESCRIPTION

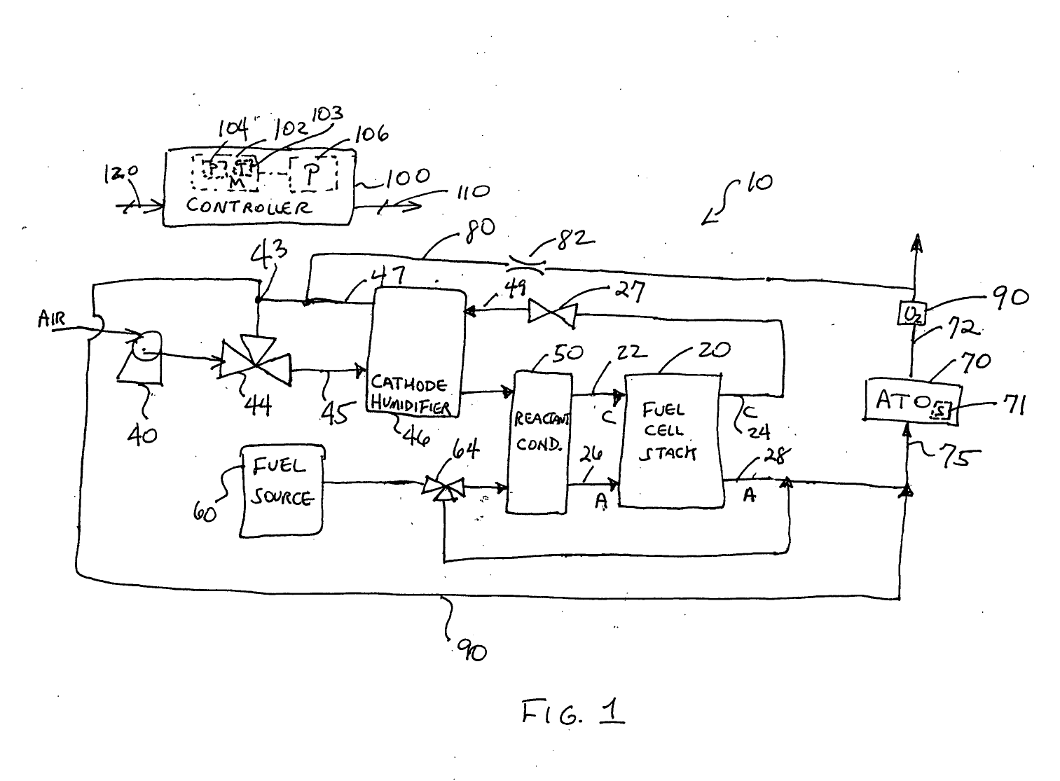

Referring to FIG. 1, an embodiment 10 of a fuel cell system in accordance with the invention includes a single air blower 40, which furnishes an oxidant flow at its outlet. For purposes of reducing the materials cost of the fuel cell system 10, the oxidant flow that is provided by the air blower 40 is split, or divided, by a three-way valve 44 for purposes of producing oxidant flows to a cathode chamber of a fuel cell stack 20 and to a reactor, or anode tailgas oxidizer (ATO) 70. As described herein, a controller 100 of the fuel cell system 10 controls the three-way valve 44 based on a state of the ATO 70 for purposes of minimizing the oxidant flow to the fuel cell stack 20 to optimize the overall system efficiency.

By controlling the oxidant flow to the fuel cell stack 20, the molar flow rate of oxidant to the fuel cells of the fuel cell stack 20 are controlled. In this regard, for a stoichiometric mixture according to Equations 1 and 2 (in the Background section), all fuel that flows through the anode chamber of the fuel cell stack 20 is consumed. However, a certain flow molar flow rate of fuel needs to be present in an anode exhaust line 28 of the fuel cell stack 20 for purposes of ensuring proper operation of the ATO 70, as further described below. By monitoring at least one state of the ATO 70, the controller 100 operates the three-way valve 44 to ensure that the minimum oxidant flow is provided to the fuel cell stack 20 to maintain the ATO 70 within predefined operating boundaries.

By ensuring that the minimum oxidant is provided to the fuel cell stack 20 to maintain proper operation of the ATO 70, the lifetime of the fuel cell stack 20 is maximized. In this regard, a relatively high oxidant flow may serve to dry out the membranes of the fuel cell stack 20, thereby reducing the lifetime of the stack 20. Additionally, by minimizing the oxidant flow to the fuel cell stack 20, the speed of the blower 40 is also minimized, thereby improving the overall efficiency of the fuel cell system 10.

The fuel cell stack 20 includes a cathode inlet 22, which receives the incoming oxidant flow to the stack 20. The incoming flow passes through the cathode chamber of the fuel cell stack 20, which represents the flow passageways through the cathodes of the fuel cells of the stack 20. The oxidant flow into the cathode inlet 22 produces a corresponding cathode exhaust, which exits the fuel cell stack 20 at a cathode outlet 24. As depicted in FIG. 1, the cathode exhaust may be routed through a valve 27 to a cathode humidifier 46. The cathode humidifier 46 uses the cathode exhaust stream to humidify the incoming oxidant stream to the fuel cell stack. In this regard, the cathode humidifier 46 transfers humidity from the outgoing cathode exhaust to the incoming oxidant stream. As depicted in FIG. 1, the cathode humidifier 46 receives its incoming oxidant stream from an outlet of the three-way valve 44. After being humidified, the oxidant stream passes through a reactant conditioner 50 to the cathode inlet of the fuel cell stack 20. The cathode exhaust exits the cathode humidifier 46 at an exhaust outlet 47, which is connected to a junction 43.

From the junction 43, the cathode exhaust may be combined with a flow from another outlet of the three-way valve 44 to form an oxidant flow, which is communicated by an oxidant communication line 90 to the ATO 70. The fuel cell system 10 also includes a bypass line 80, which is connected to the junction 43 for purposes of communicating a flow from the junction 43 to an exhaust flow from the ATO 70. As depicted in FIG. 1, the bypass line 80 may include a flow restrictor orifice 82, which may be a fixed or variable orifice, depending on the particular embodiment of the invention. The function of the bypass line 80 is to limit the maximum oxidant flow through the communication line 90 to the ATO 70. In this regard, a sufficiently high oxidant flow to the ATO 70 may lower the operating temperature of the ATO 70 outside of an acceptable operating range, thereby reducing system efficiency and possibly producing an unacceptably high level of emissions.

The fuel for the fuel cell stack 20 is provided by a fuel source 60, which may be a reformer, hydrogen tank, etc., depending on the particular embodiment of the invention. Thus, the fuel cell source 60 may provide a reformate flow, a pure hydrogen flow, etc., depending on the particular source of fuel for the fuel cell stack 20. The fuel flow that is provided by the fuel source 60 passes through a three-way valve 64 through the reactant conditioner 50. From the reactant conditioner 50, the fuel flow is received into an anode inlet 26 of the fuel cell stack 20. The anode flow is communicated through the anode chamber of the fuel cell stack 20 for purposes of sustaining the electrochemical reactions inside the fuel cell stack 20. The fuel flow through the fuel cell stack 20 produces a corresponding anode exhaust, which exits the fuel cell stack 20 at an anode exhaust outlet 28. As depicted in FIG. 1, the anode exhaust from the fuel cell stack 20 may be combined with the oxidant flow from the communication line 90 to form a feed stock flow which is provided to the ATO 70, such that the ATO 70 oxidizes the anode exhaust.

As a result of the oxidation inside the ATO 70, a relatively emission free exhaust flow is produced, which exits the ATO 70 at an outlet 72. As depicted in FIG. 1, in accordance with some embodiments of the invention, an oxygen sensor 90 is located to measure an oxygen content of the ATO's exhaust flow. More specifically, as described further below, the controller 100 uses the signal that is provided from the oxygen sensor 90 for purposes of controlling the three-way valve 44 and thereby controlling the oxidant flow to the fuel cell stack 20.

The controller 100 may take on numerous forms, depending on the particular embodiment of the invention. In general, the controller 100 includes a processor 106, which may be formed from one or more microprocessors, microcontrollers, computers, or a combination of these components. In general, the processor 106 executes program instructions 104, which are stored in a memory 102. The memory 102 may be built into the controller 100 or may be external to the controller 100, depending on the particular embodiment of the invention. The program instructions 104, when executed by the processor 106, cause the controller 100 to perform one or more of the routines to control oxidant flow, which are set forth herein. The memory 102 may also include a table 103, which sets forth the predicted control parameters, based on the system configuration 10. For example, in accordance with some embodiments of the invention, the table 103 sets forth the settings for the three-way valve 44 based on the anticipated electrical power that is provided by the fuel cell stack 20 to a load (not depicted in FIG. 1) of the fuel cell system 10.

The controller 100 includes various input communication lines 120 for purposes of possibly receiving communications from other controllers, readings from sensors, current and voltage measurements, etc. Thus, through the communication lines 120, the controller 100 observes various states, operating conditions and measurements of the fuel cell system 10. Based on these measured parameters and communications, the controller 100 may control various components of the fuel cell system 10, such as the air blower 40, the three-way valves 44 and 64, the orifice 82 (when variable), the valve 27, electrical power conditioning circuitry (not depicted in FIG. 1), the fuel source 60, etc. Thus, although the control of the three-way valve 44 is specifically discussed in detail herein, it is noted that the controller 100 may control various other aspects of the fuel cell system 10, in accordance with the many possible embodiments of the invention.

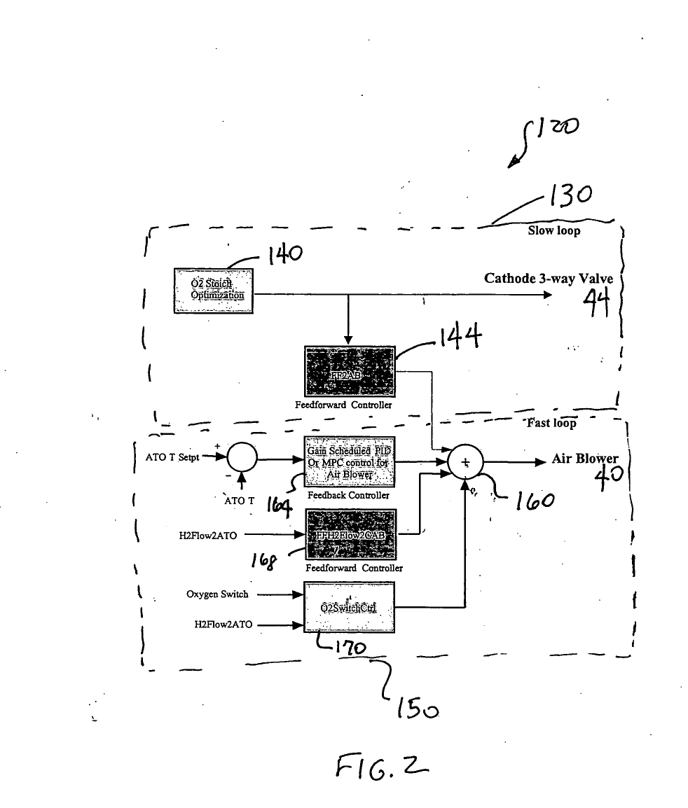

Referring to FIG. 2, in accordance with some embodiments of the invention, the controller 100 (via the execution of the program instructions 104) may implement a control and software architecture 120. Pursuant to the control and software architecture 120, the controller 100 controls the oxidant flows to the ATO 70 and fuel cell stack 20 using two control loops: a relatively slower loop 130, which controls the three-way valve 44 (i.e., controls the division of oxidant flows from the air blower 40 between the ATO 70 and fuel cell stack 20); and a relatively faster loop 150, which controls the speed of the air blower 40. In the slow loop 130, the controller 100 performs a routine 140 for purposes of optimizing the oxidant flow to the fuel cell stack 20. Besides using the result of the routine 140 to control the three-way valve 44, the controller 100 may also use the result in a feedforward controller routine 144 for purposes of controlling the air blower 40.

Regarding the fast loop 150, the controller 100 controls the speed of the air blower 40 based on several input parameters, one of which may be the feedforward result from the routine 140. The parameters on which the control of the speed of the air blower 40 is based, may be combined together, as indicated by an adder 160, which provides the speed control signal for the air blower 40. In addition to the results provided by the feedforward control routine 144, the controller 100 may also consider results provided by a routine 164, which considers feedback from the ATO 70. In this regard, the routine 164 generates a control input based on a difference between the ATO temperature 70 (measured by a sensor 71 in FIG. 1, for example) and a predetermined set point, or threshold, temperature. Thus, the actions of the routine 164 regulate the speed of the air blower 40 based on feedback of the ATO temperature for purposes of regulating the temperature to a predetermined level.

The regulation of the air blower speed is also based on the result of a routine 168, which is a feedforward control routine that generates an input to the adder 160 based on an estimated hydrogen flow to the ATO 70. In this regard, an estimate is made as to the molar flow of hydrogen that exits the anode exhaust from the fuel cell stack 20 and is provided to the ATO 70.

The fast loop 150 may also include an oxidant switching control routine 170, which receives the estimate hydrogen flow to the ATO 70 and a signal from the oxygen sensor 90 (see FIG. 1).

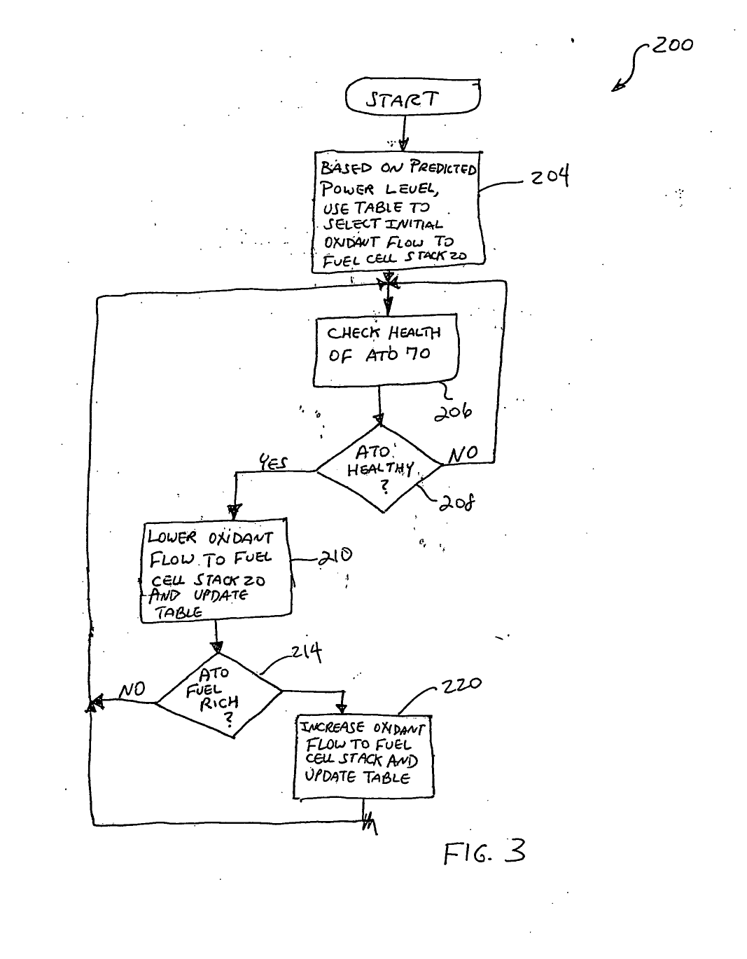

FIG. 3 depicts a technique 200 that may be performed by controller 100 due to the execution of the oxidant flow optimization routine 140. Pursuant to the technique 200, the controller 100 uses the table 103 (see FIG. 1) to select an initial oxidant flow to the fuel cell stack 20. The table 103 may specify the initial oxidant flow, may specify the controller settings for the three-way valve 44 to achieve this flow, etc., depending on the particular embodiment of the invention. Regardless of the particular content of the table 103 or other associated tables used by the controller 100, the controller 100 derives an initial setting for the three-way valve 44, i.e., determines the percentage split between the oxidant flows that are provided to the ATO 70 and the oxidant flow to the cathode chamber of the fuel cell stack 20. For example, initially, the controller 100, via the access of the cable 103 may determine that the valve 44 should be set for a 70/30 split in which 70 percent of the air flow is furnished to the ATO 70, and the remaining 30 percent is furnished to the fuel cell stack 20.

Next, pursuant to the technique 200, the controller 100 checks (block 206) the health of the ATO 70. In this regard, the controller 100 determines whether the ATO 70 is operating within the predefined boundaries. For example, the ATO 70 may be currently receiving too much air, and thus, the controller 100 may need to wait to adjust the valve 44 until the fast loop 150 (see FIG. 2) reduces the speed of the air blower 40. The controller 100 may use one or more sensors 71 (see FIG. 1) of the ATO 70 as well as possibly external sensors for purposes of ascertaining the health of the ATO 70.

After the controller 100 determines (diamond 208) that the ATO 70 is healthy, the controller 100 then lowers (block 210) the oxidant flow to the fuel cell stack 20 and updates the table 103 accordingly.

The controller 100 continually lowers the oxidant flow to the fuel cell stack 20 until a fuel rich condition is detected at the ATO 70. In this regard, when the oxidant flow through the fuel cell stack 20 becomes sufficiently low, a corresponding hydrogen flow is produced at the anode exhaust due to not enough oxygen being present in the cathode chamber of the fuel cell stack 20. Due to this condition, the ATO 70 may enter a fuel rich condition in which the oxygen content in the exhaust of the ATO 70 is below a certain threshold (such as 1000 parts per million (ppm), for example). The fuel rich condition may be detected by using the oxygen sensor 90, which indicates the oxygen content of the ATO exhaust flow.

When the controller 100 determines (diamond 214) that a fuel rich condition has occurred, the controller 100 increases the oxidant flow to the fuel cell stack 20 and updates the table, pursuant to block 220. If a fuel rich condition has not occurred, then control proceeds to block 206 to check the health of the ATO 70 before once again lowering the oxidant flow to the fuel cell stack 20.

Thus, to summarize, assuming the ATO 70 is healthy, the controller 100 lowers the oxidant flow to the fuel cell stack 20 until a fuel rich condition at the ATO 70 occurs. As a result of this control technique, the oxidant flow to the fuel cell stack 20 is minimized, thereby improving the system efficiency and extending the stack life.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell, comprising:
generating first and second oxidant flows from a source oxidant flow;
communicating the first oxidant flow to a cathode chamber of the fuel cell;
communicating the second oxidant flow to a reactor to oxidize an anode exhaust flow provided by the fuel cell; and
regulating the generation of the first flow based on a state of the oxidizer.

2. The method of claim 1, wherein the regulating comprises minimizing the first flow based on the state of the reactor.

3. The method of claim 1, wherein the regulating comprises decreasing the first flow until receiving an indication indicative that the reactor is operating outside a predetermined temperature range.

4. The method of claim 1, wherein the regulating comprises decreasing the first flow until receiving an indication indicative that the reactor is operating in a fuel rich state.

5. The method of claim 1, wherein the generating comprises:
operating a valve.

6. The method of claim 5, wherein the operating the valve comprises operating the valve to divert part of the source oxidant flow to form the first oxidant flow and divert the remaining part of the source oxidant flow to form the second oxidant flow.

7. The method of claim 1, wherein the regulating comprises determining whether a temperature associated with the reactor is below a threshold temperature.

8. The method of claim 1, wherein the regulating comprises increasing the first flow in response to a determination that the reactor is operating in a fuel rich state.

9. A fuel cell system, comprising:
an oxidant source to furnish a source oxidant flow;
a diverter to generate first and second oxidant flows from the source oxidant flow;
a fuel cell comprising a cathode chamber to receive the first oxidant flow and an anode chamber to provide an anode exhaust flow;
a reactor to receive the anode exhaust flow and the second oxidant flow and oxidizes the anode exhaust flow; and
a controller coupled to the diverter to regulate the generation of the first and second oxidant flows in response to a state of the reactor.

10. The fuel cell system of claim 9, wherein the controller is adapted to minimize the first flow based on the state of the reactor.

11. The fuel cell system of claim 9, wherein the controller is adapted to decrease the first flow until receiving an indication indicative that the reactor is operating outside of a predetermined temperature range.

12. The fuel cell system of claim 9, wherein the diverter comprises a valve.

13. The fuel cell system of claim 9, wherein the controller is adapted determine whether a temperature associated with the reactor is below a threshold temperature.

14. The fuel cell system of claim 9, wherein the controller is adapted to increase the first flow in response to a determination that the reactor is operating in a fuel rich state.

15. An article comprising a computer accessible storage medium to store instructions that when executed cause a processor-based system to:
control a diverter to generate first and second oxidant flows from a source oxidant flow, the first oxidant flow being communicated to a cathode chamber of a fuel cell and the second oxidant flow being communicated to a reactor to oxidize an anode exhaust flow provided by the fuel cell; and
regulate the generation of the first flow based on a state of the reactor.

16. The article of claim 15, the storage medium storing instructions to cause the processor-based system to minimize the first flow based on the state of the reactor.

17. The article of claim 15, the storage medium storing instructions to cause the processor-based system to increase the first flow in response to an indication that the reactor is operating in a fuel rich state.

18. The article of claim 15, the storage medium storing instructions to cause the processor-based system to operate a valve to generate the first and second oxidant flows.

19. The article of claim 18, the storage medium storing instructions to cause the processor-based system to operate the valve to divert part of the source oxidant flow to form the first oxidant flow and divert the remaining part of the source oxidant flow to form the second oxidant flow.

20. The article of claim 15, the storage medium storing instructions to cause the processor-based system to increase the first flow in response to a determination that the reactor is operating in a fuel rich state.
